(19) United States
(12) Patent Application Publication
(10) Pub. No.: US 2003/0148759 A1
(43) Pub. Date: Aug. 7, 2003

(54) Enabling and/or Inhibiting an Operation of a Wireless Communication Unit

(75) Inventor: Thomas Leliveld, Birmingham (GB)

Correspondence Address: MCGARRY BAIR PC, 171 MONROE AVENUE, N.W., SUITE 600, GRAND RAPIDS, MI, 49503, US

(73) Assignee: SENDO INTERNATIONAL LIMITED, Central (HK)

(21) Appl. No.: 10/248,596

(22) Filed: Jan. 30, 2003

(30) Foreign Application Priority Data
Feb. 1, 2002 (GB) GB 0202380.2

(51) Int. Cl. H04M 3/00; H04Q 7/20

(52) U.S. Cl. 455/418; 455/466; 455/419

(57) ABSTRACT

A wireless communication network (222) transmits (232) operation enabling and/or inhibiting information to a wireless communication unit (100, 210). In response to the information, a processor (108) of the wireless communication unit (100, 210) selectively enables or inhibits transmission and/or reception of wireless signals to and/or from the at least one wireless communication unit (100, 210) in a frequency band selected from a plurality of selectable multi-band frequencies or a signal format selected from a plurality of selectable multi-formatted signal types. This provides the advantage that an operation of a communication unit with respect to frequency bands or signal formats can be configured and re-configured, even after the communication unit has been sold to an end user. Such a reconfiguration can be at the request of the end user, or alternatively can be performed independently by the network operator or manufacturer of the communication unit.

### CROSS REFERENCE TO RELATED APPLICATIONS

This application claims priority on British Patent Application No. GB 0202380.2, filed Feb. 1, 2002.

### BACKGROUND OF THE INVENTION

1. Field of the Invention

This invention relates to a method, and apparatus for implementing the method, of enabling and/or inhibiting an operation of a wireless communication unit. The invention is applicable to, but not limited to, remote re-configuration of a wireless communication unit by a communication network.

2. Background of the Invention

In the field of this invention it is known that in order for a wireless communication unit such as a mobile phone to be able to communicate with a serving communication network, the wireless communication unit must be capable of transmitting and receiving within the same frequency band as the network with which the wireless communication unit is to communicate.

If a user wishes to ‘roam’ internationally between countries, where communication is supported by a different network operator, the user may request that his/her serving network operator enable such roaming to be allowed. Roaming, in this context, enables the user to ‘register’ on a roamed-to network, and thereby transmit and receive calls via the network operator serving this roamed-to network to/from the user's home network. This communication link typically results from a service agreement between the two network operators.

However, some wireless communication networks managed by different operators often use different frequency bands. For example, for wireless cellular-based communications in Europe there are generally two frequency bands used, namely 900 MHz (GSM) and 1800 MHz (DCS). The situation is further complicated due to the fact that in other regions of the world other frequency bands may be used for wireless cellular-based communications, for example 850 MHz (D-AMPS) and 1900 MHZ (PCS) supported in the USA.

Multi-(frequency) band wireless communication units are known. Such units may include either a multi-band antenna or two or more separate antennas, for example one for each frequency band, in order to support multi-band communications. Thus, some wireless communication units are capable of accessing a number of desirable frequency bands, in order to access a variety of wireless communication services.

Manufacturers and customers benefit from such dual-band or multi-band communication units. Manufacturers are able to offer a single wireless communication unit that can be sold to customers across many regions of the world that support multi-band communication. Therefore the manufacturers do not need to design and develop individual wireless communication units according to the specific radio frequency (RF) hardware and/or software requirements needed for each country, region or network.

A benefit to customers is that they are provided with the ability to ‘roam’ from country to country, where different frequency bands are used, without the need to carry a number of separate wireless communication units. Also, the customers benefit from less expensive communication units, as they are able to reap the cost efficiencies from manufacturers producing fewer wireless communication units to serve a number of markets.

Network operators have determined that it is sometimes desirable for a wireless cellular phone to be provided limited access to certain frequency bands, for example to limit the networks or regions or countries with which that cellular phone can be used. Such restrictions imposed on cellular users can be made either temporary or permanent. These restrictions are generally imposed upon manufacture or when the unit is marketed or sold.

For example, a multi-band device may be capable of transmitting and receiving within the 900 MHz and 1800 MHz frequency bands for Europe as well as within the 850 MHz and 1900 MHz frequency bands for the US. Network operators have marketed and sold devices in Europe that are prohibited from transmitting and receiving in non-European frequency bands.

Furthermore, network operators have implemented mechanisms for disabling all, or a significant proportion, of the functionality of a cellular phone, when the user reports the cellular phone as lost or stolen. Such a disabling operation is performed in the network, by rejecting any attempted calls to/from the cellular phone.

Within wireless communications, it is also known that a network operator assigns frequencies over-the-air to wireless communication units, to enable the wireless communication unit to access the network services or communicate with other units. Notably, such assignment of frequencies occurs ‘in-band’, i.e. within the range of frequencies allocated to a particular communication standard or protocol.

The inventor of the present invention believes that there is provision on certain wireless communication units, such as Motorola's Timeport™ cellular phone, for the user to manually switch between predefined frequency bands. However, the provision of such a manual switching feature requires the user to know when, and how, to manually switch the wireless communication unit's RF operation. Furthermore, the provision of this feature is configured at the point of manufacture, and subsequent use is solely dictated by the user's individual wishes or requirements.

A need therefore exists for an improved method and apparatus for a network operator or manufacturer to dynamically control the operation capabilities of a wireless communication unit wherein the abovementioned disadvantages may be alleviated.

### SUMMARY OF INVENTION

In accordance with a first aspect of the present invention, there is provided a wireless communication system, as claimed in claim 1.

In accordance with a second aspect of the present invention, there is provided a wireless communication unit, as claimed in claim 9.

In accordance with a third aspect of the present invention, there is provided a wireless message, as claimed in claim 11.

In accordance with a fourth aspect, the present invention provides a communication network for transmitting a wireless message, as claimed in claim 12.

In accordance with a fifth aspect, the present invention provides a method for dynamically enabling and/or inhibiting an operation of a wireless communication unit, as claimed in claim 13.

In accordance with a sixth aspect, the present invention provides a storage medium storing processor-implementable instructions, as claimed in claim 19.

Further aspects of the present invention are as claimed in the dependent claims.

In summary, the present invention proposes, inter-alia, a method, and apparatus for implementing the method, for a wireless communication network to enable or inhibit an operation of a wireless communication unit, for example with respect to a frequency band of operation or a signal format used by the wireless communication unit. If a user wishes to use the communication unit in another region, the user can request provision of service from the network operator with which they are subscribed. In this way, the network operator can charge the user for the privilege of access to communication services in other frequency bands.

### BRIEF DESCRIPTION OF DRAWINGS

Exemplary embodiments of the present invention will now be described, with reference to the accompanying drawings, in which:

FIG. 1 illustrates a wireless communication unit, adapted in accordance with a preferred embodiment of the present invention.

FIG. 2 illustrates a block diagram of a communication system or method of re-configuring an operation a wireless communication unit in such a communication system, in accordance with the preferred embodiment of the present invention.

FIG. 3 illustrates a flowchart of the preferred embodiment of the present invention.

### DETAILED DESCRIPTION

A communication unit according to a first embodiment of the present invention is capable of transmitting and receiving radio frequency (RF) signals within a plurality of frequency bands, for example 900 MHz, 1800 MHz, 850 MHz and 1900 MHz. The RF operation of the communication unit is capable of being configured such that the transmission and/or reception of signals in each frequency band can be dynamically enabled/inhibited by the network operator.

For networks that are managed by different operators, who provide for both digital and analogue communication, it is within the contemplation of the invention that a communication unit, capable of transmitting and receiving both digital and analogue signals, may be restricted to transmitting and receiving either a digital or analogue signal format. Furthermore, such enabling and/or inhibiting of signal formats may include particular modulation schemes, for example to limit the rate/amount of information a user may transmit or receive. It is within the contemplation of the invention that such restriction may be effected at the point of sale of the communication unit to the user.

Additionally, the format of the signals transmitted to or received from a communication unit may relate to the following signal formats, for example time division multiple access (TDMA), code division multiple access (CDMA), wideband CDMA, circuit switched and packet switched signals etc., which may also vary between networks. Such signaling formats include those defined by standards such as Global Systems for Mobile Communications (GSM), General Packet Radio Service (GPRS), and Universal Mobile Telecommunications System (UMTS), etc.

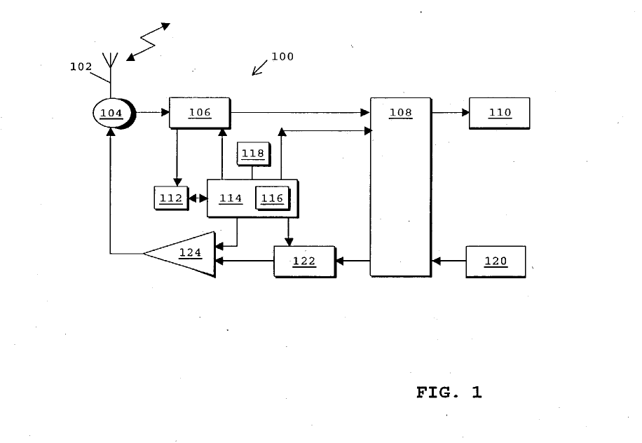

Referring first to FIG. 1, there is shown a block diagram of part of a wireless communication unit 100 adapted to support the inventive concepts of the preferred embodiments of the present invention. The communication unit 100, in the context of the preferred embodiment of the invention, is a mobile phone. As such, the communication unit 100 contains an antenna 102 preferably coupled to a duplex filter, antenna switch or circulator 104 that provides isolation between receive and transmit chains within the communication unit 100.

The receiver chain, as known in the art, includes scanning receiver front-end circuitry 106 (effectively providing reception, filtering and intermediate or base-band frequency conversion). The scanning front-end circuit is serially coupled to a signal processing function 108. An output from the signal processing function 108 is provided to a suitable output device 110, such as a screen or flat panel display.

The receiver chain also includes received signal strength indicator (RSSI) circuitry 112, which in turn is coupled to a controller 114 for maintaining overall communication unit control. The controller 114 is also coupled to the scanning receiver front-end circuitry 106 and the signal processing function 108 (generally realized by a digital signal processor (DSP)).

The controller 114 may therefore receive bit error rate (BER) or frame error rate (FER) data from recovered information. The controller is also coupled to a memory device 116 that stores operating regimes, such as decoding/encoding functions and the like. In accordance with the preferred embodiment of the present invention, the memory device 116 also includes a plurality of flags, a number of which relate to dynamically re-configurable operations of the communication unit.

A timer 118 is typically coupled to the controller 114 to control the timing of operations (transmission or reception of time-dependent signals) within the communication unit 100.

As regards the transmit chain, this essentially includes an input device 120, such as a keypad, coupled in series through transmitter/modulation circuitry 122 and a power amplifier 124 to the antenna 102. The transmitter/ modulation circuitry 122 and the power amplifier 124 are operationally responsive to the controller.

Of course, the various components within the communication unit 100 can be realized in discrete or integrated component form. It is envisaged that in alternative embodiments, the communication unit 100 may be a portable or mobile radio, a personal digital assistant, a laptop computer or a wirelessly networked PC that requires access to a communication system. The circuitry and controlling software of the transmit and receive chains of the communication unit 100 are preferably also capable of multi-band transmission and reception. Alternatively, it is within the scope of the present invention for more than one transmit and receive chain to be provided, for example one for each frequency band.

The antenna 102 is preferably a multi-band antenna, capable of transmitting and receiving signals within a plurality of frequency bands. However, it is within the scope of the present invention for more than one antenna to be provided, for example one for each frequency band.

The memory device 116 comprises, at least in part, non-volatile memory (NVM). In accordance with the preferred embodiment of the present invention, within the NVM a plurality of flags are provided, one for each frequency band. Thus, for the example described above there will be four flags, one for each of the frequency bands 850 MHz, 900 MHz, 1800 MHz and 1900 MHz.

When a flag is ‘set’, i.e. set to a first logical value, the processor 108/controller 114 arrangement configures the communication unit 100 to enable transmission and/or reception within the corresponding frequency band, from a number of selectable multi-band frequencies, as dictated by the communication network. Preferably the controller performs the setting or un-setting of flags, and the processor reads these flags in order to determine how the communication unit needs to encode and transmit, or receive and decode, particular signals. It will be appreciated by a skilled artisan that many other arrangements can be implemented to effect the re-configuration process, and the NVM/processor/controller example given above is only a preferred arrangement.

However, when the flag is ‘un-set’, i.e. set to a second logical value, the communication unit 100 is prohibited from transmitting or receiving within the corresponding frequency band.

In this manner, the communication unit 100 is capable of being dynamically re-configured to alternate frequency bands, or signal formats by configuring the respective flags in NVM. Initially the required flags may be set prior to sale of the communication unit 100 to an end user depending on, for example,

(i) The country in which the communication unit 100 is sold,

(ii) The network operator with which the user is subscribed,

(iii) The signaling formats supported by the network operator.

Hence, an existing microprocessor or digital signal processor 108 may be adapted to selectively enable or inhibit the operation of the wireless communication unit 100, based on whether a plurality of flags are set or un-set. It is envisaged that such re-programming may be effected by any suitable means, for example using an RS232 or USB communication link or over-the-air techniques, as known in the art.

As such, the required adaptation may be employed in the form of processor-implementable instructions or data stored on a storage medium, such as a floppy disk, hard disk, PROM, RAM or any combination of these or other storage multimedia.

The communication unit 100 is capable of receiving enabling and/or inhibiting information such as alternate frequency band messages via the antenna 104 and receive chain. The frequency band message preferably comprises code containing information on how to re-configure the operation of the communication unit to access the alternate frequency bands.

According to a second embodiment of the present invention, the communication unit according to the first embodiment of the present invention is additionally/alternatively capable of transmitting and receiving both digital and analogue signals. The operation of the communication unit is capable of being re-configured such that the communication unit is allowed to transmit and receive:

(i) Both digital and analogue signals;

(ii) Digital signals only; or

(iii) Analogue signals only.

According to a third embodiment of the present invention, the aforementioned communication unit is additionally/alternatively capable of transmitting and receiving wireless signals in a plurality of formats, such as time division multiple access (TDMA), code division multiple access (CDMA), circuit switched and packet switched signals, etc. Preferably, the communication unit is capable of transmitting and receiving signals having formats corresponding to a plurality of standards, such as GSM, GPRS and/or UMTS etc. The RF operation of the communication unit is therefore capable of being re-configured such that the transmission and reception of signals in one or more signal format(s) can be enabled/inhibited.

In a similar manner to the first embodiment, the NVM of the memory device 116 comprises a plurality of flags for the different signaling formats, standards, digital/analogue communication, etc. Thus, in order to support the examples described above, there will be at least additional flags for TDMA, CDMA, packet switched communication, circuit switched communication GSM communication, GPRS communication, UMTS communication, or other signaling formats such as alternative modulation schemes.

Preferably, the operation of the aforementioned communication unit, according to any of the embodiments, can be reconfigured by way of signals received using over-the-air re-programming (OTAR). The operation of the communication unit may also be reconfigured by way of signals received by other means, such as using an RS232 interface provided on the communication unit, infrared signals received using an IrDa interface provided on the communication unit, etc.

Software, for example stored in the memory device 116, is used to process the message code contained within the enabling and/or inhibiting information message and sets and/or un-sets one or more of the frequency band flags located in the NVM. The enabling and/or inhibiting information message may be in the form of a short message service (SMS) message, a Wireless Access Protocol (WAP) message, an Unstructured Supplementary Service Data (USSD) message, an email or any other suitable form.

The message code contains information that, when processed, instructs the controller 114 as to which flags should be set and/or unset. Furthermore, the code may contain information relating to periods of time for which each flag is to be set/unset. Once these time periods have expired, the flags may be returned to their previous state. In this way the communication unit 100 can be allowed access to specific frequency bands for a variable, and controllable, limited period of time.

Where the communication unit receives a plurality of message codes, whether simultaneously or at different times, each code may comprise a priority value, providing a means for deciding the optical communication unit operation when a conflict in the message codes exists. For example, where the communication unit receives two enabling and/or inhibiting information message codes, one instructing that access to the 1800 MHz frequency band be allowed, the other instructing that access to the 1800 MHz frequency band be inhibited, and the two message codes comprise different priority levels, the one with the highest priority takes precedent.

Alternatively, where there is a conflict, the code having the latest date of transmission or reception will take precedent.

The enabling and/or inhibiting information code preferably contains one or more of the following categories of update/re-configuration information:

(i) Permanently set one or more flags;

(ii) Permanently unset one or more flags;

(iii) Temporarily set one or more flags for a period of time, following which return each flag to its prior state;

(iv) Temporarily un-set one or more flags for a period of time, following which return each flag to its prior state;

(v) Temporarily set one or more flags for a period of time, following which unset each flag, irrespective of its prior state; and/or

(vi) Temporarily un-set one or more flags for a period of time, following which set each flag, irrespective of its prior state.

The enabling and/or inhibiting information message received by the communication unit 100 is preferably generated, e.g. by the network operator or the manufacturer of the communication unit, in response to a request by the user. The request may be made in any manner, for example by SMS message, utilizing WAP, email, the Internet, by making a phone call or by visiting a shop or other place of business of the network operator, manufacturer, etc. The user may make such a request when, say, traveling to another region that supports alternative frequency bands or signaling formats to the user's home network. As the network operator dynamically controls the enabling and/or inhibiting of operational conditions of the user's wireless communication unit, the network operator can charge the user for the privilege of re-configuring the user's communication unit to operate in other communication services in other regions.

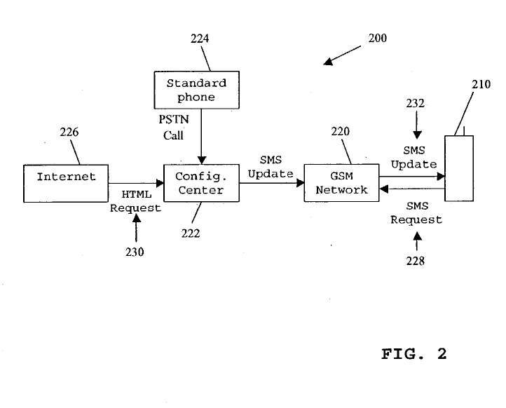

FIG. 2 illustrates a method and system arrangement 200 according to the present invention, by which a user of a communication unit 210 may request and subsequently receive an enabling and/or inhibiting information message for the communication unit 210. The communication unit 210 is in communication with a network, which for the illustrated embodiment is a GSM network 220.

Also in communication with the GSM network 220 is a configuration center 222. The configuration center 222 is also in communication with one or more telephones 224 via a public switched telephone network (PSTN) and/or the Internet 226.

When the user of the communication unit 210 wishes to re-configure the operation of the communication unit 210, the user sends a re-configuration message request, which for the illustrated embodiment is in the form of a Short Message Service (SMS) message 228, to the configuration center 222 via the GSM network 220.

Alternatively, the user may request an operational re-configuration using the Internet 226, sending, for example, an HTML request 230 to the configuration center 222.

The data provided in the update request message 228, whether originating from the communication unit 210 or via the Internet 226, preferably comprises one or more of the following information items:

(i) An indication of the enabling and/or inhibiting information required;

(ii) An indication of one or more period(s) of time (where required) for which the operational re-configuration(s) is (are) to be set and/or unset;

(iii) An indication as to the identity of the communication unit, such as the international mobile equipment identification (IMEI) number of the device. This may alternatively be provided in the standard message format rather than in the data provided in the message, if the request message originates from the communication unit 210; or

(iv) An indication as to the identity of the user, such as the international mobile subscriber identification (IMSI) number of, for example, a subscriber identity module (SIM) of the user. This may alternatively be provided in the standard message format rather than in the data provided in the message, if the request message originates from the communication unit 210.

A further alternative, when operational restrictions have been imposed on the communication unit, is for the user to request an operational re-configuration by way of a telephone call via the PSTN, using the standard telephone 224. The user may make such a request verbally, for example by speaking to a person located at the configuration center 222, or by sending signals, such as a dual-tone multi-frequency (DTMF) signals, which are processed by an automated system at the configuration center 222.

When the configuration center 222 receives a re-configuration message request, the configuration center 222 sends an enabling and/or inhibiting information message, which for the illustrated embodiment is in the form of a SMS message 232, via the GSM network 220, to the communication unit 210.

The enabling and/or inhibiting information SMS message 232 is preferably constructed, in accordance with GSM 03.40: Digital cellular telecommunications systems (Phase 2); Technical realization of the Short Message Services (SMS); Point-to-Point (PP) of the GSM standards, to indicate that the SMS message 232 contains an instruction (as opposed to, say, a text message).

The instruction contained within the SMS message 232 comprises the enabling and/or inhibiting information message code to be processed by the software stored in the memory of the communication unit 210. When processed, the enabling and/or inhibiting information message code instructs the controller 114 of the communication unit as to which operation or configuration flag(s) should be set and/or un-set, as previously described.

The message may include a text message to be displayed to the user of the communication unit, informing the user of the receipt of a re-configuration message. Alternatively, the communication unit, on receipt of the message, may display a pre-stored message, or indicate by any other means, for example any audible, tactile or visual indication, to the user informing the user that the communication unit has received a re-configuration message.

Alternatively, the re-configuration message may be in the form of a standard SMS text message. The text within the message includes the message code, which can be entered manually by the user into the communication unit for processing by the software stored in memory.

Preferably, prior to sending the re-configuration message, confirmation is carried out at the configuration center 222 as to the validity of the request. For example, the user may be required to register with the configuration center 222 in order to re-configure his/her communication unit. Alternatively, it may be necessary to check that the hardware and/or software of the communication unit is capable of performing the requested re-configuration.

If the request is found to be invalid, a message such as an SMS message is sent to the communication unit, informing the communication unit and/or user that an invalid request has been made. The message may include a text message to be displayed to the user of the communication unit, informing the user of the invalid request. Alternatively the communication unit, on receipt of the message, may display a pre-stored message to the user informing the user that the communication unit has received a message stating that an invalid request has been made.

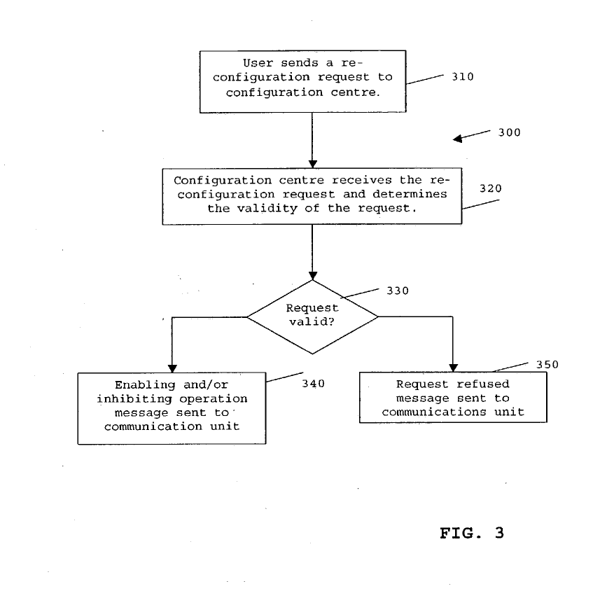

FIG. 3 shows a flowchart of a preferred process 300 of the present invention. The first step 310 is for the user to send an operation re-configuration message request to the configuration center. Such a re-configuration message request may be in any suitable form, for example from the communication unit itself (e.g. by SMS message), over the Internet, or via a PSTN using a normal telephone.

The configuration center receives the operation re-configuration message request 320, and determines the validity of the message request 330.

If the update message request is valid, an enabling and/or inhibiting information message, say in the form of an SMS message, is sent to the communication unit. The message contains information on the re-configuration of frequency band(s) and/or signal format(s), for example by setting and/or un-setting respective flags in a memory element, for the wireless communication unit.

If the request is determined to be invalid, a message is sent to the communication unit to inform the communication unit and/or user that the request is invalid.

It is envisaged that the enabling and/or inhibiting operation message could, additionally be performed, for example at a point of sale, whereby an RS232 serial interface, IrDa interface, Bluetooth wireless interface, or any other known form of interface could be used to provide the update code to the communication unit.

It will be understood that the improved wireless communication system and method for dynamically enabling and/or inhibiting frequency band and/or signal format operations of a wireless communication unit, as described above, provides at; least the advantage that the operation of a communication unit can be dynamically configured and re-configured under control of the network or communication unit manufacturer. Notably, such control can be effected after the communication unit has been sold to an end user. In particular, it does not require the user to know the communication bands or signaling formats supported in the region or country (s)he is visiting, so that they can perform the re-configuration operation themselves.

Furthermore, the aforementioned concepts provide a network operator with more control over the communication units serviced by their network. In addition, the network operator is provided with a real-time, dynamic mechanism for re-configuring the operational aspects of the wireless communication units, at the unit itself. Such control is in contrast to the known mechanism of restricting all calls to/from the communication unit at the network, when the unit is reported as stolen or lost.

Advantageously, such a re-configuration can be at the request of the end user. Alternatively, the re-configuration can be performed independently by the network operator, for which they could levy a charge to the user. Alternatively, the re-configuration can be performed by the communication unit manufacturer, for example by returning the unit to a service center for re-programming/re-configuring, for which they could also levy a charge to the user.

Whilst the specific and preferred implementations of the embodiments of the present invention are described above, it is clear that one skilled in the art could readily apply variations and modifications of such inventive concepts to particular embodiments or arrangements.

Thus, an improved wireless communication system and method for dynamically enabling and/or inhibiting an operation of a wireless communication unit has been described wherein the aforementioned disadvantages associated with prior art arrangements have been substantially alleviated.

1. A wireless communication system for dynamically enabling and/or inhibiting an operation of at least one wireless communication unit operating in the wireless communication system, the wireless communication system comprising:
a communication network to facilitate wireless communication to and/or from a wireless communication unit; and
at least one wireless communication unit comprising a processor for selectively enabling and/or inhibiting an operational condition of said at least one wireless communication unit;
wherein said wireless communication network transmits operation enabling and/or inhibiting information to the at least one communication unit and in response to said information, said processor selectively enables or inhibits transmission and/or reception of wireless signals to and/or from the at least one wireless communication unit in:
(i) A frequency band selected from a plurality of selectable multi-band frequencies, or
(ii) a signal format selected from a plurality of selectable multi-formatted signal types.

2. The communication system according to claim 1, wherein said multi-formatted signals includes one or more of the following:
(i) analogue or digital communication formats;
(ii) modulation schemes;
(iii) One or more signaling formats or communication standards.

3. The communication system according to claim 1, wherein said communication network transmits operation enabling and/or inhibiting information to the at least one communication unit using:
(i) A wired interface, preferably an RS232 interface, provided on the communication unit, or
(ii) an infrared interface provided on the communication unit, or
(iii) A wireless message such as a short message service (SMS) message, a Wireless Access Protocol (WAP) message, an unstructured supplementary service data (USSD) message, or a wireless email.

4. The communication system according to claim 1, wherein said communication unit is permitted access to:
(i) said frequency band selected from a plurality of selectable multi-band frequencies, or
(ii) said signal format selected from a plurality of selectable multi-formatted signal types,
for a temporary and/or variable time period determined by the communication network in said information.

5. The communication system according to claim 1, wherein said communication unit further comprises a memory element operably coupled to the processor and containing a number of flags related respectively to a number of said selectable multi-band frequencies or selectable multi-formatted signal types and a controller operably coupled to the processor and memory element for setting or unsetting said flags in response to the processed information.

6. The communication system according to claim 5, wherein said information contains one or more of the following categories of information:
(i) Permanently set or un-set one or more flags;
(ii) Temporarily set or un-set one or more flags for a period of time, following which each flag is returned to its prior state;
(iii) Temporarily set one or more flags for a period of time, following which each flag is set or un-set, irrespective of its prior state.

7. The communication system according to claim 1, wherein said information includes a priority value that provides a mechanism for resolving a conflict between subsequent information messages.

8. The communication system according to claim 1, wherein said information includes one or more of the following:
(i) An indication of the radio frequency operation or frequency band to be enabled or inhibited in the communication unit;
(ii) An indication of a period of time for which the enabling and/or inhibiting operation is to be performed;
(iii) An indication as to the identity of the communication unit, such as the international mobile equipment identification (IMEI) number of the communication unit, or
(iv) An indication as to the identity of a user of the communication unit, such as the international mobile subscriber identification (IMSI) number of, for example,a subscriber identity module (SIM) of the user.

9. A wireless communication unit adapted to operate in the wireless communication system of claim 1.

10. The communication unit according to claim 9, wherein the communication unit is one of the following: a cellular phone, a portable or mobile radio, a personal digital assistant, a laptop computer or a wirelessly networked personal computer.

11. A wireless message for enabling and/or inhibiting a wireless communication unit, operating in the wireless communication system of claim 1, from operating in or with:
(i) A frequency band selected from a plurality of selectable multi-band frequencies, or
(ii) A signal format selected from a plurality of selectable multi-formatted signal types.

12. A communication network adapted to transmit a wireless message according to claim 11 to a wireless communication unit.

13. A method for dynamically enabling and/or inhibiting an operation of at least one wireless communication unit operating in a wireless communication system, the method comprising the steps of:
transmitting a wireless information message to said at least one wireless communication unit to enable or inhibit an operation of the at least one wireless communication unit;
enabling and/or inhibiting transmission and/or reception of wireless signals to and/or from the at least one wireless communication unit, in response to said information message, in:
(i) A frequency band selected from a plurality of selectable multi-band frequencies, or
(ii) a signal format selected from a plurality of selectable multi-formatted signal types.

14. The method according to claim 13, wherein said multi-formatted signals includes one or more of the following:
(i) Analogue or digital communication formats;
(ii) Modulation schemes;
(ii) One or more signaling formats or communication standards.

15. The method according to claim 13, wherein said step of transmitting includes using:
(i) A wired interface, preferably an RS232 interface, provided on the communication unit, or
(ii) An infrared interface provided on the communication unit, or
(iii) A wireless message such as a short message service (SMS) message, a Wireless Access Protocol (WAP) message, an unstructured supplementary service data (USSD) message, or a wireless email.

16. The method according to claim 13, the method further comprising the step of:
providing, via said message, temporary access of the communication unit to:
(i) said frequency band selected from a plurality of selectable multi-band frequencies, or
(ii) said signal format selected from a plurality of selectable multi-formatted signal types.

17. The method according to claim 13, wherein said information message includes a priority value, the method further comprising the step of:
providing a mechanism for resolving a conflict between subsequent information messages using said priority value.

18. The method according to claim 13, wherein said information includes one or more of the following:
(i) An indication of a radio frequency operation or frequency band to be enabled or inhibited in the communication unit;
(ii) An indication of a period of time for which the enabling and/or inhibiting operation is to be performed;
(iii) An indication as to the identity of the communication unit, such as the international mobile equipment identification (IMEI) number of the communication unit, or
(iv) An indication as to the identity of a user of the communication unit, such as the international mobile subscriber identification (IMSI) number of, for example, a subscriber identity module (SIM) of the user.

19. A storage medium storing processor-implementable instructions for controlling a processor to perform the method steps of claim 13.

20. A wireless communication system according to claim 1, wherein the plurality of selectable multi-formatted signal types includes at least one of the following: time division multiple access (TDMA), code division multiple access (CDMA), wideband CDMA, circuit switched and packet switched signals, Global System for Mobile communications (GSM), General Packet Radio Service (GPRS), Universal Mobile Telecommunications System (UMTS).

21. A wireless communication unit according to claim 9, wherein the plurality of selectable multi-formatted signal types includes at least one of the following: time division multiple access (TDMA), code division multiple access (CDMA), wideband CDMA, circuit switched and packet switched signals, Global System for Mobile communications (GSM), General Packet Radio Service (GPRS), Universal Mobile Telecommunications System (UMTS).

22. A wireless message according to claim 11, wherein the plurality of selectable multi-formatted signal types includes at least one of the following: time division multiple access (TDMA), code division multiple access (CDMA), wideband CDMA, circuit switched and packet switched signals, Global System for Mobile communications (GSM), General Packet Radio Service (GPRS), Universal Mobile Telecommunications System (UMTS).

23. A communication network for transmitting a wireless message according to claim 12, wherein the plurality of selectable multi-formatted signal types includes at least one of the following: time division multiple access (TDMA), code division multiple access (CDMA), wideband CDMA, circuit switched and packet switched signals, Global System for Mobile communications (GSM), General Packet Radio Service (GPRS), Universal Mobile Telecommunications System (UMTS).

24. A method for dynamically enabling or disabling an operation of a wireless communication unit according to claim 13, wherein the plurality of selectable multi-formatted signal types includes at least one of the following: time division multiple access (TDMA), code division multiple access (CDMA), wideband CDMA, circuit switched and packet switched signals, Global System for Mobile communications (GSM), General Packet Radio Service (GPRS), Universal Mobile Telecommunications System (UMTS).

25. A wireless communication system according to claim 1, wherein the plurality of selectable frequency bands includes at least one of the following: 850 MHz, 900 MHz, 1800 MHz and 1900 MHz.

26. A wireless communication unit according to claim 9, wherein the plurality of selectable frequency bands includes at least one of the following: 850 MHz, 900. MHz, 1800 MHz and 1900 MHz.

27. A wireless message according to claim 11, wherein the plurality of selectable frequency bands includes at least one of the following: 850 MHz, 900 MHz, 1800 MHz and 1900 MHz.

28. A communication network for transmitting a wireless message according to claim 12, wherein the plurality of selectable frequency bands includes at least one of the following: 850 MHz, 900 MHz, 1800 MHz and 1900 MHz.

29. A method for dynamically enabling or disabling an operation of a wireless communication unit according to claim 13, wherein the plurality of selectable frequency bands includes at least one of the following: 850 MHz, 900 MHz, 1800 MHz and 1900 MHz.
